(19) United States
(12) Patent Application Publication
(10) Pub. No.: US 2003/0057830 A1
(43) Pub. Date: Mar. 27, 2003

(54) SPUTTER RESISTANT SECONDARY EMISSION COATING FOR ELECTRODES

(76) Inventor: YOSHIHIRO KANNO, GIFU (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 09/474,900

(22) Filed: Dec. 30, 1999

(30) Foreign Application Priority Data
Jan. 11, 1999 (JP) P11-003543

(51) Int. Cl. H01J 17/49

(52) U.S. Cl. 313/582

(57) ABSTRACT

A plasma cell constituting a display device includes a pair of substrates, bonded to each other with a pre-set gap in-between for defining a hermetically sealed space in-between, an ionizable gas charged into the space and discharge electrodes formed on at least one of the substrates for ionizing the gas for producing electrical discharge in the space. The discharge electrodes are overcoated by a film-shaped substance formed by an electro-deposition method. This substance has resistance against sputtering for protecting the discharge electrodes against impacts by the ionized gas and secondary electron emitting characteristics enabling electrical discharge. The substance is selected from the group of borides, carbides, oxides, nitrides, metals and metalloids., and has sufficient resistance against sputtering to eliminate or suppress the amount of mercury used.

### BACKGROUND OF THE INVENTION

1. Field of the Invention

This invention relates to a display device of a flat panel structure exploiting plasma discharge, and a manufacturing method therefor.

2. Description of the Related Art

The display device of a flat panel structure, exploiting plasma discharge, includes a pair of substrates, bonded to each other with pre-set gap in between to define a hermetically closes space, an ionizable gas charged therein and electrodes formed at least on one of the substrates for ionizing the gas to generate electrical discharge in the space defined between the paired substrates.

The electrodes also operate as an anode and a cathode. There may be provided barrier ribs separating the paired electrodes formed on the substrate from each other.

The electrodes for electrical discharge, used in conventional plasma display device, are routinely produced by a printing method. Specifically, an electrically conductive paste is coated by e.g., screen printing, on a substrate, and fired at hundreds of degrees centigrade to electrodes. The electrode material is routinely aluminum or nickel.

These electrodes suffer from several problems yet to be solved. First, the electrode material is oxidized by the firing process. Since heating at a temperature of the order of 500 to 600° C. is required for the firing process for the electrodes, the electrode material, such as aluminum or nickel, is unavoidably oxidized. The barrier ribs, routinely formed by printing of a glass paste, need to be heated at 500 to 600° C. in the firing process, so that the electrodes formed in the previous step are unavoidably oxidized. If thermal expansion at the time of firing is taken into account, the currently usable electrically conductive paste is only nickel or aluminum, such that it is difficult to improve resistance against oxidation.

The second problem to be solved is resistance against sputtering. In the conventional plasma display device, the electrode material was insufficient in its resistance against sputtering when DC discharge is produced between the anode and the cathode. In order to combat this problem, mercury vapor is added to an inert gas for electrical discharge in the conventional nickel electrode. If aluminum is used as an electrode material, a current limiting resistor is used. These measures cannot be said to be sufficient from the practical point of view.

The conventional electrode material suffers the problem of the increased discharge voltage. That is, since nickel and aluminum are higher in the work function, the discharge voltage becomes necessarily higher. The conventional practice is to utilize the penning phenomenon to lower the discharge voltage. These measures can again not be said to be satisfactory.

For improving resistance against sputtering and reducing the discharge voltage, a coating film is continuously applied by printing on a thick electrode formed by printing and firing. The characteristics required of the coating (overcoat) are resistance against sputtering and a low work function. Thus, borides or carbides, having these characteristics in combination, have been selected as the overcoating material. However, similarly to the electrodes, the conventional overcoating undergoes oxidation during the firing process, such that fully satisfactory characteristics cannot be realized.

### SUMMARY OF THE INVENTION

It is therefore an object of the present invention to provide an overcoat having the resistance against sputtering and the low work function on the discharge electrodes.

In one aspect, the present invention provides a display device including a pair of substrates, bonded to each other with a pre-set gap in-between for defining a hermetically sealed space in-between, an ionizable gas charged into the space and electrodes formed on at least one of the substrates for ionizing the gas for producing electrical discharge in the space, wherein the electrodes are coated by a material formed by an electro-deposition method, the material exhibiting resistance against sputtering necessary for protecting the electrodes against impacts of an ionized gas and also exhibiting secondary electron emitting characteristics enabling at least the electrical discharge. The material is selected from the group of borides, carbides, oxides, nitrides, metals and metalloids. The material also has resistance against sputtering sufficient to eliminate or suppress the amount of mercury used. The electrodes are thick-filmed electrodes obtained on firing an electrically conductive paste coated on a substrate by a printing method. The electrodes are also thick-filmed electrodes formed on a substrate by a plating method.

In another aspect, the present invention provides a method for producing a display device including a pair of substrates, bonded to each other with a pre-set gap in-between for defining a hermetically sealed space in-between, an ionizable gas charged into the space and electrodes formed on at least one of the substrates for ionizing the gas for producing electrical discharge in the space, wherein the method includes forming the electrodes on the substrates and coating the electrodes with a preset material by an electro-deposition method to protect the electrodes from impacts by the gas.

In yet another aspect, the present invention provides a display device having a flat panel structure comprised of a display cell and a plasma cell superposed one on another via an intermediate substrate. The display cell has an upper substrate bonded to the intermediate substrate via a pre-set gap, an electro-optical substance held in the gap, and signal electrodes formed in columns on the upper substrate so that picture signals are applied thereto. The plasma cell includes a lower substrate bonded to the intermediate substrate with a pre-set gap to define a hermetically sealed space, an ionizable gas charged into the space, and scanning electrodes formed in columns on the lower substrate to ionize the gas to produce electric discharge in the space. The scanning electrodes are sequentially scanned to write picture signals supplied to the signal electrodes on the electro-optical substance. The scanning electrodes are coated by a filmed material formed by an electro-deposition method. The material exhibits resistance against sputtering necessary for protecting the electrodes against impacts of an ionized gas and also exhibits secondary electron emitting characteristics enabling at least the electrical discharge.

The present invention uses an electro-deposition method for forming an overcoat effective for an electrode for plasma discharge. In the electro-deposition method, an overcoating can be applied after forming discharge electrodes or the barrier ribs, so that oxidation of materials can be suppressed to a minimum. The electrode material may be enumerated by routine nickel or aluminum and an overcoat material may be enumerated by borides, carbides, oxides, nitrides, metals and metalloids. This suppresses chronological deterioration of discharge electrodes while decreasing the discharge voltage. If the discharge electrodes are overcoated, the overcoating material is required to have as high secondary electron emitting characteristics as possible in order to enable plasma discharge. The index in this connection is the work function. The lower the work function, the higher become the secondary electron emission characteristics to enable plasma discharge to be maintained in stability.

### BRIEF DESCRIPTION OF THE DRAWINGS

FIG. 1 is a schematic cross-sectional view showing a display device according to the present invention.

FIGS. 2A to 2D illustrate the manufacturing method for a display device according to the present invention, step-by-step.

FIG. 3 is a schematic view showing an electrical depsotion vessel used in the manufacturing method for a display device according to the present invention.

FIG. 4 is a schematic view for illustrating the operatin of the display device according to the present invention.

### DESCRIPTION OF THE PREFERRED EMBODIMENTS

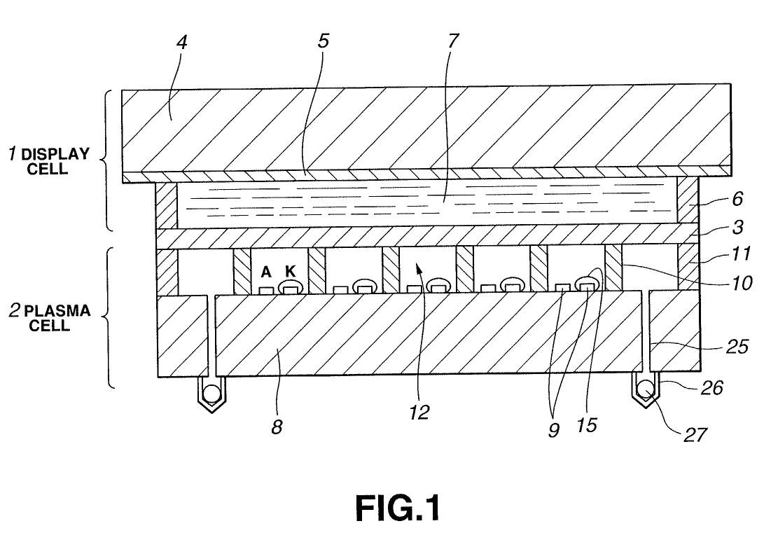

Referring to the drawings, preferred embodiments of a display device and a manufacturing method according to the present invention will be explained in detail. The embodiment shown in FIG. 1 is directed to a plasma address display device usable for addressing a display cell 1 typified by a liquid crystal cell. The present invention is, however, not limited to this embodiment and may naturally be applied to a plasma display device employing a plasma cell of the flat panel structure by itself.

As shown, the plasma address display device includes a display cell 1, a plasma cell 2 and an intermediate substrate 3 interposed therebetween. The plasma cell 2 is constituted by a lower substrate 8 connected to the intermediate substrate 3 and an ionizable gas is sealed in-between. Among gas species used, there are inert gases, such as, for example, krypton or xenon. On the inner surface of the lower substrate 8 are formed stripe-shaped discharge electrodes 9.

The discharge electrode 9 is formed by printing and sintering on the planar lower substrate 8 so that it is superior in productivity or workability while permitting miniaturisation. Meanwhile, the discharge electrode 9 may also be formed by a plating method, such as a nickel plating method, in place of the printing method. With the plating method, both electro-plating and electroless plating are usable. In the case of the electro-plating, aluminum or nickel is formed at the outset by a sputtering method to a thickness of the order of 0.2 μm and nickel is then plated to a thickness of 5 μm to produce a desired thick-film electrode.

Every two of plural discharge electrodes 9 are separated by barrier ribs 10. The barrier ribs 10 divide the spacing, in which is sealed the ionizable gas, to constitute discharge channels 12. These barrier ribs 10 also can be formed by printing by e.g., a screen printing method, followed by firing. The upper ends of the barrier ribs 10 compress against the lower surface of the intermediate substrate 3. The paired discharge electrode 9, surrounded by neighboring barrier ribs 10, operate as an anode A and a cathode K, across which plasma discharge is produced. The intermediate substrate 3 and the lower substrate 8 are bonded to each other by a sealing material 11, such as glass frit.

The display cell 1 is constituted by a transparent upper substrate 4 which is bonded by e.g., an adhesive 6 to the intermediate substrate 3 with a pre-set gap in-between. The gap is charged with an electro-optical material 7, such as a liquid crystal. On the inner surface of the upper substrate 4 are formed signal electrodes 5 extending at right angles to the stripe-shaped discharge electrodes 9. There are defined matrix-shaped pixels at the intersections of the signal electrodes 5 and the discharge channels 12.

In the above-described plasma address display device, the discharge channels 12, as rows, across which occurs the plasma discharge, are scanned line-sequentially. Picture signals are applied to the signal electrodes 5, as columns, provided on the display cell 1, in synchronism with the scanning, by way of performing display driving. If plasma discharge occurs in the discharge channels 12, the inside of the discharge channels 12 is set uniformly to an anode potential so that pixels are selected on the column basis. That is, the discharge channels 12 operate as a sampling switch.

If picture signals are applied to the respective pixels in the on-state of the plasma sampling switch, the sampling occurs to control turning on or off of pixels. The picture signals are held unchanged in the pixels even after turning off of the plasma sampling switch. Meanwhile, the present embodiment is of the dc driving type in which one of the paired discharge electrodes 9 allocated to each discharge channel 12 is the anode A, with the other discharge electrode 9 being a cathode K. However, the present invention is not limited to this embodiment and can, of course, be applied to the ac driving system.

As characteristic of the present invention, at least the discharge electrode 9 operating as the cathode K is coated with a film-like material applied by an electro-deposition method to form an electro-deposited film 15. The material constituting the electro-deposited film 15 has resistance against sputtering necessary to protect the discharge electrodes 9 against the shock from the gas ionized in the discharge channels 12, while also having secondary electron emitting characteristics for enabling at least plasma discharge.

For reducing the discharge voltage, higher secondary electron emission characteristics (lower work function) are preferred. In general, the ionized gases are charged to positive polarity and are forced to collide against and sputter the cathode K which is at a negative potential with respect to the anode A. For preventing this sputtering from occurring, at least the discharge electrodes 9 operating as the cathode K are coated with the electro-deposited film 15.

The material of the electro-deposited film 15 is selected from a group of borides, carbides, oxides, nitrides, metals and metalloids. The conditions for selection include superior resistance against sputtering and a low work function. The discharge electrodes 9 are thick-filmed electrodes, produced on firing the electrically conductive paste coated by printing on the substrate 8, as discussed above. The discharge electrodes 9 may also be thick-filmed electrodes formed by plating on the substrate. By using the thick-filmed electrodes, formed by printing or plating, it is possible to prevent line breakage otherwise caused by an excessive current at the time of unusual electric discharge. A thin-filmed electrode, formed by vacuum deposition or sputtering, is apt to be broken easily by such excessive current.

According to the present invention, the electro-deposition method is used to form an effective overcoat as well as to maintain simplicity of the thick-filmed electrode formed by vacuum deposition or sputtering, low cost and resistance against excessive current. As the electrode material for the discharge electrodes 9, nickel or aluminum, as routine electrode material, is used. As a material for the electro-deposited film 15 (overcoat), borides, carbides, oxides, nitrides, metals and metalloids, having superior resistance against sputtering and a low work function, as described above, are used.

In the embodiment, shown in FIG. 1, the inner space of the plasma cell is evacuated via an air discharge duct 25 opened in the lower substrate 8 and a glass tip tube 26 communicating therewith. An ionizable gas then is charged into the inner space of the cell and the glass tip tube 26 is sealed off. In the inside of the glass tip tube 26 is retained a getter which is heated to absorb unneeded gases other than the ionizable gases. If desired, a trace amount of mercury may be supplied to the inside of the glass tip tube 26, in addition to the getter 27, and is heated so that the mercury vapor is charged into the inner space of the plasma cell 2.

In general, the mercury vapor is introduced to prevent deterioration of the discharge electrodes 9 due to sputtering. In the present invention, it is frequently unnecessary to introduce the mercury vapor because the discharge electrodes 9 are coated with the electro-deposited film 15 having superior resistance against sputtering. However, the mercury vapor may be introduced for improving the resistance against sputtering. However, the amount of the mercury may be suppressed as compared with the conventional system. Stated differently, the material of the electro-deposited film 15 exhibits resistance against sputtering sufficient to allow for elimination or suppression of the amount of mercury used.

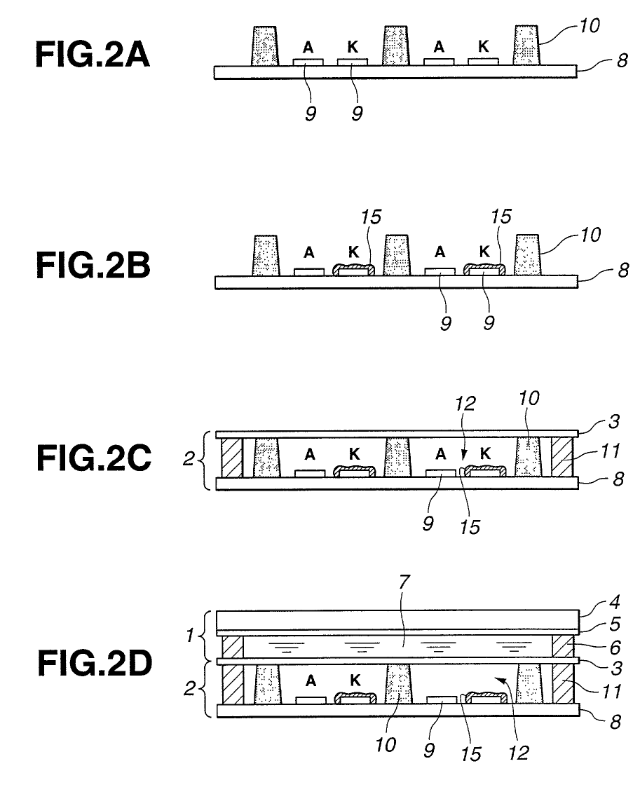

FIGS. 2A to 2D are process diagrams illustrating the manufacturing method of the display device according to the present invention. Referring first to FIG. 2A, discharge electrodes 9, which prove the anode A and the cathode K, are formed on a rinsed lower substrate 8. The electrodes were formed by printing, using a nickel paste. For improving the opening ratio, sandblasting may also be used. In the sandblasting method, an electrically conductive paste is applied by printing at the outset on the entire surface of the lower substrate 8 and subsequently dried. The resulting substrate then is selectively ground, using a fine mask, to produce stripe-shaped discharge electrodes 9. If the printing method is used, the substrate is dried after printing to vaporize the solvent, and is then provisionally fired to remove the unneeded binder resin. Then, nickel powders in the electrically conductive paste are immobilized by dissolving glass particles by firing. The temperature reached in heating is as high as approximately 500 to 600° C. After forming the discharge electrodes 9, the barrier ribs 10 are formed by a glass paste by the printing method. Terminal electrodes for connection, not shown, then are formed by the printing method. The barrier ribs 10 and the terminal electrodes may also be formed by firing simultaneously with the discharge electrodes 9, if so desired.

The electro-deposited film 15, serving as a protective layer for the discharge electrodes 9, then is formed for completely coating at least the cathode K, as shown in FIG. 2B. The material of the electro-deposited film 15 may be selected from the group of borides, carbides, oxides, nitrides, metals and metalloids. The liquid used for electro-deposition is routinely a colloidal solution obtained on mixing powders of a desired material for coating and low-melting glass particles, as a binder, and ions for affording electrical charges to the powders of the coating material, into a solvent, such as water or isopropyl alcohol. The coated electro-deposited film 15 is dried and fired in an inert gas atmosphere approximately 400° C. for deposition fixedly on the substrate 8.

The intermediate substrate 3, formed by a thin glass sheet, then is connected by a frit 11 to the lower substrate 8, as shown in FIG. 2C. The spacing defined between the lower substrate 8 and the intermediate substrate 3 is partitioned by barrier ribs 10 to constitute discharge channels 12, in which to seal an ionizable gas. This completes the plasma cell 2.

Finally, the display cell 1 is assembled on the plasma cell 2 to complete the plasma address display device. The display cell 1 is assembled, using the upper substrate 4, and has the signal electrode 5 formed on its inner surface. The upper substrate 4 is bonded by a sealing material 6 on the intermediate substrate 3. A liquid crystal, for example, is sealed as an electro-optical material 7 between the upper substrate 4 and the intermediate substrate 3.

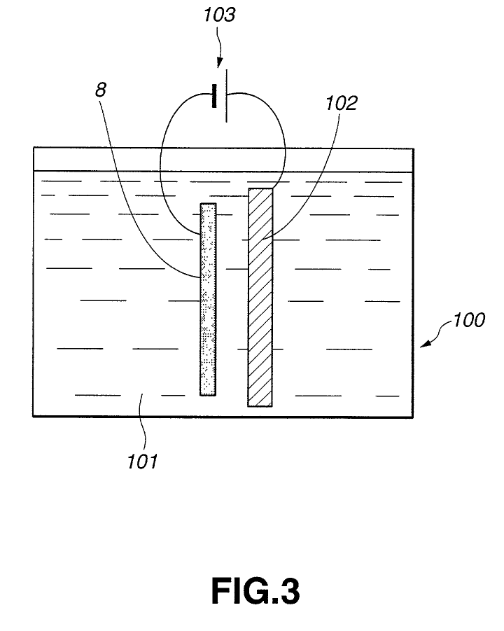

FIG. 3 is a cross-sectional view showing an electro-deposition vessel 100 used for forming the electro-deposited film 15. An electro-deposition liquid 101 is charged into the electro-deposition vessel 100 as shown. The electrode substrate 8 to be processed and a counter-electrode 102 are immersed in the vessel. A power source 103 is interposed therebetween. The electrode substrate 8 and the counter-electrode 102 operate as a negative electrode and a positive electrode, respectively. On the electrode substrate 8, the discharge electrodes, operating as cathodes, are connected in common and to the negative electrode of the power source 103.

The power source 103 has an output voltage of the order of, for example, 30 V, with the separation between the electrode substrate 8 and the counter-electrode 102 being of the order of, for example, 10 mm. In the structure of the electro-deposition vessel 100, electro-deposition is carried out for e.g., 1 to 10 minutes to deposit an electro-deposited film which is 3 to 10 μm in thickness.

The electro-deposition liquid 101 is a colloidal solution comprised of a solvent, powders of the coating material, low-melting glass for a binder and ions for affording electrical charges to these powders. For example, isopropyl alcohol is used as the solvent. LaB6, lead glass and Mg ions are used as the coating material, low-melting glass and as ions for affording electrical charges, respectively.

The electrode substrate 8 is immersed in the electro-deposition liquid 101, having the above composition, and is connected to the negative electrode of the power source 103, whilst the counter-electrode 102, formed of, for example, stainless steel, is connected to the positive electrode of the power source 103, to apply the voltage across the electrode substrate 8 and the counter-electrode 102. The powders of the material, doped with positive ions in the electro-deposition liquid 101, are deposited on the electrodes.

The coating film thickness is controlled by the voltage applied across the electrode substrate 8 and the counter-electrode 102 and the electro-deposition time. It is noted that LaB6 (lanthanum hexaboride) used as the coating material is superior in resistance against sputtering and low in the work function. On the other hand, the low-melting lead glass, used as a coating material, can be sintered at a temperature not higher than 400° C. The borides other than LaB6, as a preferred electro-deposition film, may be exemplified by NbB6, GdB6 and YB6.

Examples of the usable oxides are conductors, such as LaSrMnO3, LaSrCoO3 and LaCaCrO3, and non-conductors, such as Y2O3 or MgO. Examples of the usable nitrides are BN, TaN, TiN and ZrN, whereas those of the usable carbides are HfC, TaC and ZrC. Examples of the metals are W, Ta, Mo and Nb, whereas an example of the metalloids is C. These materials are, however, merely illustrative and are not intended for limiting the invention.

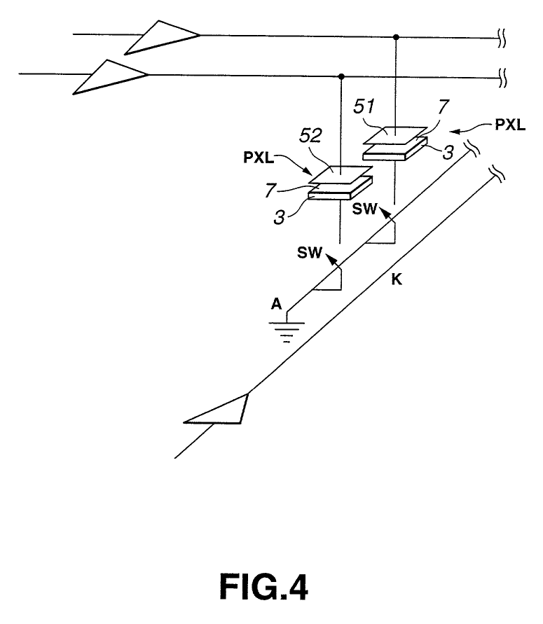

Referring to FIG. 4, the operation of the plasma address display device according to the present invention is explained. In FIG. 4, two signal electrodes 51, 52, a sole cathode K and a sole anode A only are shown for aiding in the understanding. Each pixel PXL has a layered structure comprised of signal electrodes 51, 52, an electro-optical material 7, the intermediate substrate 3 and a discharge channel.

During plasma discharge, each discharge channel is substantially connected to an anode potential. If, in this state, picture signals are applied to the pixels, electrical charges are implanted into the electro-optical material 7 and the intermediate substrate 3. If the plasma discharge comes to a close, the discharge channel is reset to the insulated state, so that the potential is the floating potential such that implanted electrical charges are held in the pixels PXL, by way of performing the sample-and-hold operation. The discharge channels operate as individual sampling switch devices and hence are indicated schematically as switching symbols SW.

On the other hand, the electro-optical material 7 and the intermediate substrate 3, sandwiched between the signal electrodes 51, 52 and the discharge channels, operate as sampling capacitors. If the sampling switches SW are in the conducting state, by line-sequential scanning, picture signals are held in the sampling capacitors, so that the respective pixels are turned on or off depending on the signal voltage level. After the sampling switches SW are turned off, the signal voltage is held on the sampling capacitors to continue the active matrix operation of the display device.

According to the present invention, as described above, the coating material having resistance against sputtering and a low work function is applied by the electro-deposition method on the electrode surface, as the simplicity of the thick-film electrode formed by the printing or plating method, low cost and resistance against excessive current are maintained. Since the coating can be applied after the process of firing the electrodes or the barrier ribs, oxidation of the material can be suppressed to a minimum. As the electrode material, routine materials, such as nickel or aluminum, are used. As the electro-deposition film, borides, carbides, oxides, nitrides, metals and metalloids, having superior resistance against sputtering and a low work function, are used. This suppresses chronological deterioration of the discharge electrodes, while allowing for the lowering of the discharge voltage.

What is claimed is:

1. A display device comprising a pair of substrates, bonded to each other with a preset gap in-between for defining a hermetically sealed space in-between, an ionizable gas charged into said space and electrodes formed on at least one of said substrates for ionizing said gas for producing electrical discharge in said space;
wherein
said electrodes are coated by a material formed by an electro-deposition method;
said material exhibiting resistance against sputtering necessary for protecting said electrodes against impacts of an ionized gas and also exhibiting secondary electron emitting characteristics enabling at least said electrical discharge.

2. The display device according to claim 1
wherein
said material is selected from the group of borides, carbides, oxides, nitrides, metals and metalloids.

3. The display device according to claim 2
wherein
said material has resistance against sputtering sufficient to eliminate or suppress the amount of mercury used.

4. The display device according to claim 1
wherein
said electrodes are thick-filmed electrodes obtained on firing an electrically conductive paste coated on a substrate by a printing method.

5. The display device according to claim 1
wherein
said electrodes are thick-filmed electrodes formed on a substrate by a plating method.

6. A method for producing a display device comprising a pair of substrates, bonded to each other with a pre-set gap in-between for defining a hermetically sealed space in-between, an ionizable gas charged into said space and electrodes formed on at least one of said substrates for ionizing said gas for producing electrical discharge in said space;
said method comprising:
forming said electrodes on said substrates; and
coating said electrodes with a pre-set material by an electro-deposition method to protect said electrodes from impacts by said gas.

7. A display device having a flat panel structure comprised of a display cell and a plasma cell superposed one on another via an intermediate substrate;
said display cell having an upper substrate bonded to said intermediate substrate via a pre-set gap, an electro-optical substance held in said gap, and signal electrodes formed in columns on said upper substrate so that picture signals are applied thereto;
said plasma cell including a lower substrate bonded to said intermediate substrate with a pre-set gap to define a hermetically sealed space, an ionizable gas charged into said space, and scanning electrodes formed in columns on said lower substrate to ionize said gas to produce electric discharge in said space;
said scanning electrodes being sequentially scanned to write picture signals supplied to said signal electrodes on said electro-optical substance;
wherein
said scanning electrodes are coated by a filmed material formed by an electro-deposition method;
said material exhibiting resistance against sputtering necessary for protecting said electrodes against impacts of an ionized gas and also exhibiting secondary electron emitting characteristics enabling at least said electrical discharge.
